(19) United States
(12) Patent Application Publication
(10) Pub. No.: US 2007/0248854 A1
(43) Pub. Date: Oct. 25, 2007

(54) POWER GENERATION MODULE, SYSTEM, AND METHOD FOR DRIVING THE POWER GENERATION MODULE

(75) Inventors: Hiroyasu Bitoh, Tokyo (JP); Yasunari Kabasawa, Hanno-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/693,566

(22) Filed: Mar. 29, 2007

(30) Foreign Application Priority Data
Mar. 30, 2006 (JP) 2006-093930

(51) Int. Cl. H01M 8/04

(52) U.S. Cl. 429/17

(57) ABSTRACT

Disclosed is a power generation module including a fuel take-in unit to take in fuel from at least one of a plurality of fuel containers, the fuel take-in unit being coupled with the plurality of fuel containers; a power generator to generate electricity by using the fuel supplied from the at least one of the plurality of fuel containers; and a by-product discharger to discharge a by-product, which is generated during the generation of the electricity by the power generator, selectively to the at least one of the plurality of fuel containers.

### BACKGROUND OF THE INVENTION

1. Field of the Invention

The present invention relates to a power generation module, a system, and a method of driving the power generation module, and more particularly to a power generation module that generates electricity by being supplied with fuel from a plurality of fuel containers, a system provided with the power generation module, and a method of driving the power generation module.

2. Description of the Related Art

In recent years, small-sized electronic equipments such as a portable telephone, a laptop personal computer, a digital camera, a wrist watch, a personal digital assistance (PDA) and an electronic personal organizer have made remarkable progress and development. As a power source of the electronic equipments, primary batteries such as an alkaline dry cell and a manganese dry cell, and secondary batteries such as a nickel-cadmium storage cell, a nickel-hydrogen storage cell and a lithium ion cell are used. Nowadays, research and development activities with respect to fuel cells, which can realize high energy use efficiency, have been being actively performed in order to substitute the primary batteries and the secondary batteries.

The fuel cell is a battery that converts chemical energy into electric energy by electrochemically reacting fuel with the oxygen in the atmosphere. Since the fuel cell utilizes the electrochemical reaction that directly converts the chemical energy of the fuel into the electric energy, by-products are produced by the reaction and are discharged. The major component of such by-products is water, and carbon dioxide is also sometimes generated. In addition, unreacted hydrogen, air and the like are discharged. There are some cases where such discharged substances are recovered into a fuel cartridge mounted on a fuel cell system (power generation system).

Many conventional fuel cell systems have one fuel cartridge. Moreover, even in a case where the conventional fuel system is mounted with a plurality of fuel cartridges, a water recovering cartridge is provided separately (see, for example, Japanese Patent Application Publication (Laid-Open) No. 2004-192171), or discharge is conducted to the plurality of fuel cartridges without switching the emission.

In a case where exhaustion is performed to the plurality of fuel cartridges as described above, there is a fear that the pressure of the fuel cartridge, from which the fuel is taken and thus the fuel still remains, remarkably rises and results in damage of the fuel cartridge.

### SUMMARY OF THE INVENTION

The present invention was made in view of the situation mentioned above, and it is a primary object to provide a power generation module capable of recovering by-products to a fuel container safely, a system provided with the power generation module, and a method of driving the power generation module.

According to a first aspect of the present invention, there is provided a power generation module comprising:

a fuel take-in unit to take in fuel from at least one of a plurality of fuel containers, the fuel take-in unit being coupled with the plurality of fuel containers;

a power generator to generate electricity by using the fuel supplied from the at least one of the plurality of fuel containers; and

a by-product discharger to discharge a by-product, which is generated during the generation of the electricity by the power generator, selectively to the at least one of the plurality of fuel containers.

According to a second aspect of the present invention, there is provided a system comprising:

a power generation module comprising:

a fuel take-in unit to take in fuel from at least one of a plurality of fuel containers, the fuel take-in unit being coupled with the plurality of fuel containers;

a power generator to generate electricity by using the fuel supplied from the at least one of the plurality of fuel containers; and

a by-product discharger to discharge a by-product, which is generated during the generation of the electricity by the power generator, selectively to the at least one of the plurality of fuel containers; and

an electronic equipment that operates based on electric energy generated by the power generation module.

According to a third aspect of the present invention, there is provided a power generation module comprising:

a fuel take-in unit to take in fuel from a plurality of fuel containers simultaneously, in a case where a pressure value of each of the plurality of fuel containers is equal to a predetermined pressure or more and a pressure loss in each of the plurality of fuel containers is substantially the same, the fuel take-in unit being coupled with the plurality of fuel containers;

a power generator to generate electricity by using the fuel supplied from the plurality of fuel containers; and

a by-product discharger to discharge a by-product which is generated during the generation of the electricity by the power generator, to the plurality of fuel containers simultaneously.

According to a fourth aspect of the present invention, there is provided a method of driving a power generation module comprising the steps of:

taking in fuel from at least one of a plurality of fuel containers, in a state of being coupled with the plurality of fuel containers;

generating electricity by using the fuel supplied from the at least one of the plurality of fuel containers; and

discharging a by-product which is generated during the generation of the electricity, to the at least one of the plurality of fuel containers selectively.

### BRIEF DESCRIPTION OF THE DRAWINGS

The above and further objects, features and advantages of the present invention will become more apparent from the following detailed description taken in conjunction with the accompanying drawings, wherein:

FIG. 1 is an exploded perspective view of a fuel container for illustrating a first embodiment of the present invention;

FIG. 2A is a top view of the fuel container for illustrating the first embodiment of the present invention;

FIG. 2B is a cross-sectional view of FIG. 2A when cut along a cutting plane line II-II and is viewed from the direction indicated by arrows;

FIG. 3 is a block diagram showing a schematic configuration of a power generation system for illustrating the first embodiment of the present invention;

FIG. 4 is a flow chart showing an operation of a first or a second fuel pump and a switching operation processing of a third valve, for illustrating the first embodiment of the present invention;

FIG. 5A is a top view of an electronic equipment for illustrating the first embodiment of the present invention;

FIG. 5B is a bottom view when the electronic equipment of FIG. 5A is viewed from the bottom side thereof;

FIG. 5C is a rear view when the electronic equipment of FIG. 5B is viewed from the rear face side;

FIG. 6 is an exploded perspective view of a fuel container for illustrating a second embodiment of the present invention;

FIG. 7A is a top view of the fuel container for illustrating the second embodiment of the present invention;

FIG. 7B is a cross-sectional view of FIG. 7A when cut along a cutting plane line VII-VII and is viewed from the direction indicated by arrows;

FIG. 8 is a block diagram showing a schematic configuration of a power generation system for illustrating the second embodiment of the present invention;

FIG. 9A is a top view of an electronic equipment for illustrating the second embodiment of the present invention;

FIG. 9B is a right side view when the electronic equipment of FIG. 9A is viewed from the right side thereof; and

FIG. 9C is a rear view when the electronic equipment of FIG. 9A is viewed from the rear face side.

### DETAILED DESCRIPTION OF THE PREFERRED EMBODIMENTS

In the following, the preferred embodiments for implementing the present invention will be described with reference to the attached drawings. However, the scope of the present invention is not limited to the shown examples.

### First Embodiment

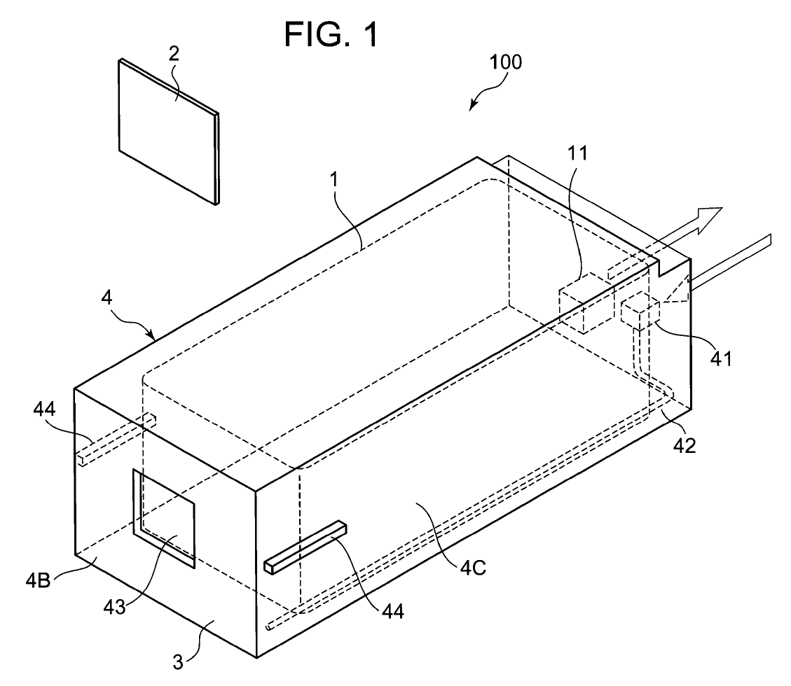

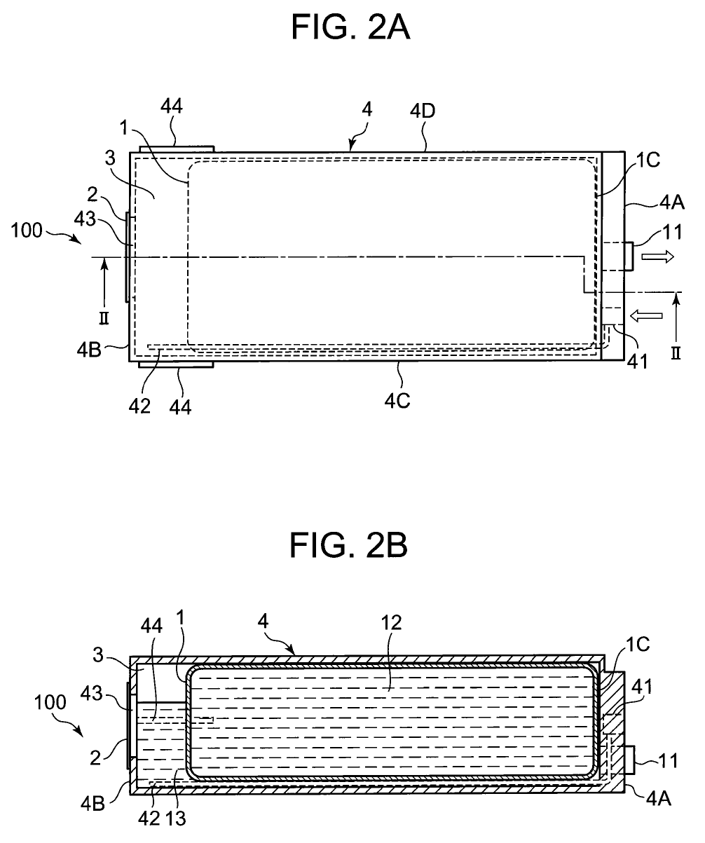

FIG. 1 is an exploded perspective view of a fuel container 100; FIG. 2A is a top view of the fuel container 100; and FIG. 2B is a cross-sectional view when cut along a cutting plane line II-II and is viewed from the direction indicated by arrows.

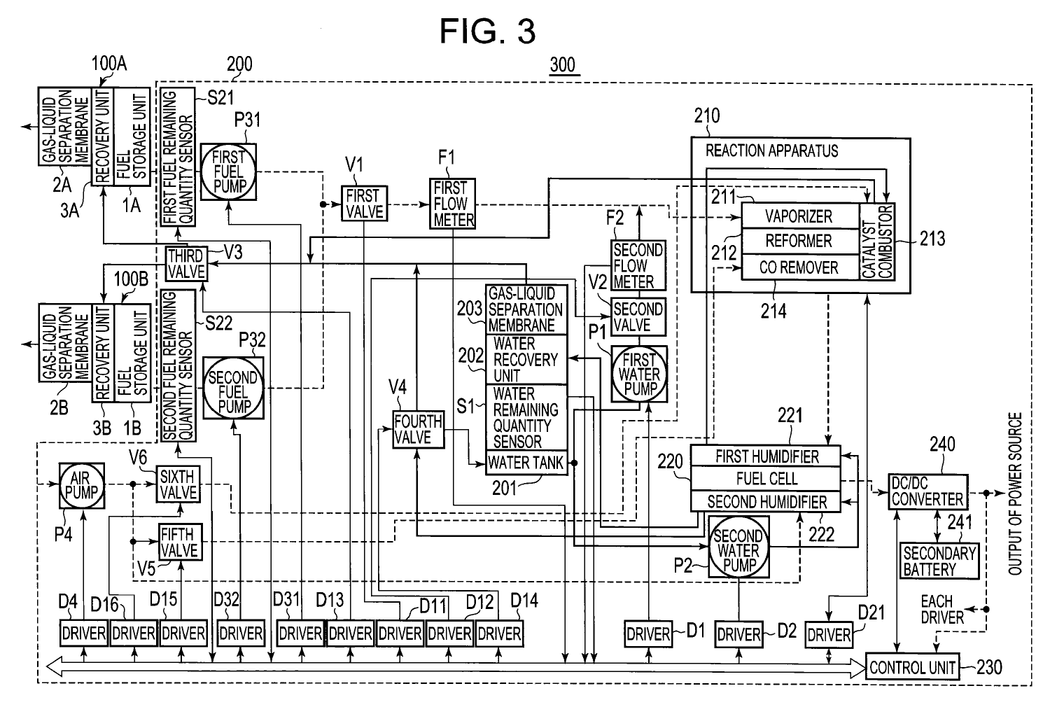

The fuel container 100 can be freely coupled to a power generation module 200 (see FIG. 3). The fuel container 100 is provided with a fuel storage unit 1 which stores fuel 12, and a recovery unit 3 which cools and recovers the discharges including a gas and a water 13, both of which are discharged from the power generation module 200 which generates electricity based on the fuel 12 supplied from the fuel storage unit 1.

The fuel storage unit 1 has a bag-like shaped thin deformable form which stores the fuel 12 therein, and is housed in a box-like housing 4.

The fuel 12 is a chemical fuel in single, or is a mixture of the chemical fuel and water. As the chemical fuel, compounds containing hydrogen atom, for example, alcohols such as methanol and ethanol, ethers such as dimethyl ether, and gasoline can be used. In the present embodiment, uniform mixture of the methanol stored in the fuel storage unit 1 and water is used as a chemical reaction material.

A fuel discharge unit 11 to discharge the fuel 12 to the power generation module 200 is formed in a convex manner at an end face 1C (the end face on the right side in FIG. 1) in the lengthwise direction of the fuel storage unit 1 so as to project from the end face 1C to the outside, the fuel discharge unit 11 penetrating through the end face 4A on the right side of the housing 4.

A fuel discharge opening (not shown), which is a through hole for discharging the fuel 12 into the fuel storage unit 1, is formed at the convex top of the head of the fuel discharge unit 11, and a check valve (not shown) is fitted into the fuel discharge opening, the check valve preventing the unnecessary discharge of the fuel 12 from the inside to the outside of the fuel storage unit 11 through the fuel discharge unit 11. To put it concretely, the check valve is a duckbill valve made by forming a material having flexibility and elasticity into a duckbill shape, and the check valve is fitted into the fuel discharge unit 11 with the duckbill-like tip facing towards the inside of the fuel storage unit 1. As the materials having the flexibility elasticity, ethylene propylene diene rubber (EPDM), butyl rubber and the like can be mentioned. Since the butyl rubber generally shows lower permeability to gases among the elastic material polymers, it is preferable to select the butyl rubber in practical use for producing parts having smaller sizes. Moreover, since the check valve does not have any mechanically complicated structures, the capacity thereof can be made to small, and thus the cost can be lowered. An insertion hole may be formed in the check valve in advance, the insertion hole allowing the inside of the fuel storage unit 1 communicate with the outside thereof when a fuel supply pipe (not shown) provided on the side of the power generation module 200, which will be described later, is inserted. Moreover, the structure in which the insertion hole is not formed until the fuel supply pipe is inserted, may be also adopted. In the case of forming the insertion hole in advance, the check valve is designed so that force is applied in the direction of closing the insertion hole around the insertion hole by an internal pressure of the fuel 12, in the inner part of the fuel storage unit 1, when the fuel 12 is filled up in the fuel storage unit 1. In addition, the check valve tends to recover its original shape due to the elastic restoring force thereof. Consequently, no gap is formed around the fuel supply pipe inserted into the insertion hole, and the fuel 12 does not unnecessarily leak from the insertion hole to the outside of the fuel storage unit 1. Then, by the insertion of the fuel supply pipe of the power generation module 200, the fuel 12 is discharged from the fuel storage unit 1 to the power generation module 200 through the fuel discharge unit 11 and the fuel supply pipe.

The recovery unit 3 is a spacial portion which is on the outside of the fuel storage unit 1 and is in the left side of the housing 4. As the fuel 12 in the fuel storage unit 1 decreases, the capacity in the bag-like shaped fuel storage unit 1 decreases. Consequently, the capacity of the recovery unit 3 relatively increases, and the recovery unit 3 becomes able to recover the water 13 for the amount of its capacity. A small quantity of water 13 is charged into the recovery unit 3 in advance. Therefore even in a case where the state of the water at the time when the water is being recovered into the recovery unit 3 is vapor, the vapor is cooled by the water 13 charged into the recovery unit 3 in advance, and the vapor liquefies to shrink. Consequently, the recovery of the water is efficiently accelerated while the capacity of the recovery unit 3 is suppressed. Liquids other than the water 13 and solids containing agents such as calcium chloride may also be used for cooling.

The housing 4 is transparent or translucent, and is made of a material such as polyethylene, polypropylene, polycarbonate or acrylic resin.

The fuel discharge unit 11 formed on the fuel storage unit 1 penetrates through the end face 4A on the right side of the housing 4 and projects to the outside.

Moreover, on the right end face 4A of the housing 4 and above the fuel discharge unit 11, a convex emission supply unit 41 which communicates with the inside of the housing 4 and is supplied with discharges discharged from the power generation module 200, which will be described later, is embedded to the hosing 4.

An discharge supply opening (not shown), which is a through hole for supplying the discharges into the housing 4, is formed at the convex top of the head of the discharge supply unit 41, and a check valve (not shown) is fitted to prevent the unnecessary discharge of the discharges, which is temporarily supplied into the housing 4 through the discharge supply unit 41 in the housing 4, to the outside of the housing 4. Specifically, a check valve similar to that the one fitted in the fuel discharge unit 11 can be used. Further, a discharge supply pipe 42 to supply discharges into the recovery unit 3 through the check valve is provided in the discharge supply unit 41. The discharge supply pipe 42 is arranged from the discharge supply unit 41 to the bottom side of the fuel storage unit 1, and extends along the lengthwise direction of the housing 4 to the spacial portion in the left end of the housing 4.

A rectangular opening portion 43 communicating with the inside of the housing 4 is formed on the other end face 4B (the end face on the left side in FIG. 1) in the lengthwise direction of the housing 4. A gas-liquid separation membrane 2 containing a hydrophobic porous membrane having a gas-liquid separating function is attached to the opening portion 43 so as to cover the opening portion 43. The gas-liquid separation membrane 2, which transmits gas and does not transmit liquid, is a rectangular thin membrane, and is made of polyethylene, polypropylene, polyacrylonitrile, polymethyl methacrylate, a cellulose-based resin such as cellulose acetate and cellulose triacetate, a polysulfone-based resin such as polyether sulfone and polysulfone, and the like for example. Consequently, gas can pass through the gas-liquid separation membrane 2 from the inside to the outside of the housing 4 and vice versa, and the water 13 cannot pass through the gas-liquid separation membrane 2. Therefore, the water 13 does not leak to the outside.

Furthermore, in order to freely attach and detach to electronic equipment 400, which will be described later, each of guide portions 44, 44 is attached to the front surface 4C and the rear surface 4D in the left end side of the housing 4. The guide portions 44, 44 extend linearly on the front surface 4C and the rear surface 4D along the longitudinal direction of the housing 4.

In the fuel container 100 mentioned above, the fuel 12 in the fuel storage unit 1 is supplied into the power generation module 200, which will be described later, through the fuel discharge unit 11, and electric energy is taken out by using the fuel 12. Moreover, the discharges generated by the power generation module 200 are supplied into the discharge supply pipe 42 through the discharge supply unit 41, and then the discharges flow through the discharge supply pipe 42 to be sent into the recovery unit 3. The vapor in the gases contained in the discharges is cooled during circulating inside the discharge supply pipe 42 or is cooled by the water 13 in the recovery unit 3, and is condensed into water 13. Then, the water 13 is recovered by the recovery unit 3. The gases that have not been condensed pass through the gas-liquid separation membrane 2 to be discharged to the outside. Since the water 13 is a liquid and cannot pass through the gas-liquid separation membrane 2, the water 13 is reserved in the recovery unit 3.

FIG. 3 is a block diagram showing a schematic configuration of a power generation system 300 provided with a first fuel container 100A and a second fuel container 100B, each having the configuration similar to that of the fuel container 100 mentioned above, and the power generation module 200. Since each component constituting the first fuel container 100A corresponds to each component of the fuel container 100 mentioned above, each component of the first fuel container 100A is denoted by a reference numeral with a letter A added to the reference numeral of the corresponding component of the fuel container 100, and each component of the second fuel container 100B is denoted by a reference numeral with a letter B added to the reference numeral of the corresponding component of the fuel container 100 in the following descriptions.

The power generation system 300 is composed of the first fuel container 100A, the second fuel container 100B and the power generation module 200 generating electricity by using the fuel 12 supplied by the first and the second fuel containers 100A and 100B. The power generation system 300 generates electricity with the power generation module 200 by using the fuel 12 supplied from the fuel container (100A or 100B) having a smaller remaining quantity of the fuel 12 between the first and the second fuel containers 100A and 100B, and the power generation system 300 is controlled so that the discharges discharged from the power generation module 200 is recovered by the recovery unit (3A or 3B) of the fuel container (100A or 100B) that is supplying the fuel 12.

The power generation module 200 is provided with a water tank 201 storing water, a reaction apparatus 210 generating hydrogen from the fuel 12 supplied from the first and the second fuel containers 100A and 100B and the water supplied from the water tank 201, and a fuel cell 220 generating electric energy by the electrochemical reaction of the hydrogen. Moreover, the power generation module 200 is provided with a first humidifier 221 humidifying the hydrogen generated in the reaction apparatus 210 to be supplied to the humidified hydrogen to the anode of the fuel cell 220, and a second humidifier 222 humidifying the air to be supplied to the cathode of the fuel cell 220. The electrolyte membrane of the fuel cell 220 is in the state in which the electrolyte membrane is humidified by the air and the reformed gas that have been humidified by the first humidifier 221 and the second humidifier 222. Supply of water to the first humidifier 221 and the second humidifier 222 is preferably started just before starting the generation of electricity by the fuel cell 220, and the water may be supplied during the generation of electricity by the fuel cell 220, or the water may be supplied just before starting the generation of the electricity in a case where the water, which is generated when the electricity is generated by the fuel cell 220, permeates the whole electrolyte membrane.

The water tank 201 stores water, and a first water pump P1 and a second water pump P2, which will be described later, supply the stored water to the vaporizer 211, and to the first and the second humidifiers 221 and 222 of the reaction apparatus 210. As will be described later, the discharges (such as water and air) discharged from the cathode of the fuel cell 220 are temporarily recovered by a water recovery unit 202, and then the water that is subjected to vapor-liquid separation by the gas-liquid separation membrane 203, containing a hydrophobic membrane and is provided to the water recovery unit 202, is stored in the water tank 201. The gas containing the vapor, which is separated by the gas-liquid separation membrane 203, is lead to the recovery unit (3A or 3B) of the fuel container (100A or 100B) that is supplying the fuel 12. Furthermore, the water discharged from the first and the second humidifiers 221 and 222 is also stored in the water tank 201.

The water tank 201 is provided with a water remaining quantity sensor S1 detecting the remaining quantity of the water stored in the water tank 201. The water remaining quantity sensor S1 measures the remaining quantity of the water stored in the water tank 201, and outputs an electric signal of the measurement result to a control unit 230.

The reaction apparatus 210 is provided with the vaporizer 211 vaporizing the fuel 12 and the water that have been supplied from the first fuel container 10A, the second fuel container 100B and the water tank 201, to generate a fuel gas (a gaseous mixture of the vaporized fuel and vapor), a reformer 212 reforming the fuel gas supplied from the vaporizer 211 as expressed by a chemical reaction equation (1) to generate a reformed gas, a catalyst combustor 213 heating the reformer 212 to set the reformer 212 at a temperature necessary for performing the reaction of the chemical reaction equation (1) in a good condition, and a CO remover 214 oxidizing and removing the carbon monoxide CO as expressed by a chemical reaction equation (3), the carbon monoxide being generated in a trace amount as a by-product through a chemical reaction expressed by a chemical reaction equation (2), which takes place subsequently to the reaction expressed by the chemical reaction equation (1). Moreover, the reaction apparatus 210 is also provided with a heater combined with thermometer (not shown) that serves as an electric heater heating the vaporizer 211, the catalyst combustor 213 and the CO remover 214, and also serves as a thermometer measuring their temperatures.

CH₃OH+H₂O→3H₂+CO₂ (1)

H₂+CO₂→H₂O+CO (2)

2CO+O₂→2CO₂ (3)

The first humidifier 221 humidifies the hydrogen, which is contained in the reformed gas generated by the CO remover 214, with the water supplied from the water tank 201 and supplies the humidified hydrogen to the anode of the fuel cell 220.

The second humidifier 222 humidifies the air, which is supplied from an air pump P4, with the water supplied from the water tank 201 and supplies the humidified air to the cathode of the fuel cell 220. The unnecessary water discharged from the second humidifier 222 is recovered by the water tank 201.

The fuel cell 220 is provided with the anode that supports catalyst fine particles, the cathode that supports catalyst fine particles, and a film-shaped solid polymeric electrolyte membrane arranged between the anode and the cathode. The hydrogen supplied from the CO remover 214 is supplied to the anode of the fuel cell 220, and the air is supplied to the cathode of the fuel cell 220 by the air pump P4, which will be described later. At the anode, the hydrogen in the gaseous mixture is separated to hydrogen ions and electrons due to catalytic effect of the catalyst fine particles of the anode as expressed by an electrochemical reaction equation (4). The hydrogen ions are conducted to the cathode through the solid polymeric electrolyte membrane, and the electrons are extracted as electric energy (generated electric power) by the anode. At the cathode, the electrons that moved to the cathode, the oxygen in the air, and the hydrogen ions that passed through the solid polymeric electrolyte membrane undergoes an electrochemical reaction as expressed by an electrochemical reaction equation (5) and generate water. Then, the offgas containing the unreacted hydrogen at the anode is sent to the catalyst combustor 213, and the water and the unreacted air generated at the cathode are sent to the water recovery unit 202 as discharges.

H₂→2H+2e⁻ (4)

2H⁺+1/2O₂+2e⁻→H₂O (5)

Besides the first and the second fuel containers 100A and 100B, the water tank 201, the reaction apparatus 210, the fuel cell 220 and the like, the power generation system 300 is also provided with a first fuel pump P31 supplying the fuel 12 in the first fuel container 100A to the vaporizer 211, a second fuel pump P32 supplying the fuel 12 in the second fuel container 100B to the vaporizer 211, a first water pump P1 supplying the water in the water tank 201 to the vaporizer 211, a second water pump P2 supplying the water in the water tank 201 to the first and the second humidifiers 221 and 222, and an air pump P4 introducing the air from the open air into the power generation system 300.

A first valve V1 is connected to the first fuel pump P31 and to the second fuel pump P32, and a first flow meter F1 is connected to the first valve V1. The first valve V1 is provided between the first and the second fuel pumps P31 and P32, and the vaporizer 211. The first valve V1 is configured to intercept or allow the flow of the fuel 12 from the first fuel pump P31 to the vaporizer 211 by a switching action thereof, and is further configured to intercept or allow the flow of the fuel 12 from the second fuel pump P32 to the vaporizer 211. The first flow meter F1 is provided between the first valve V1 and the vaporizer 211, and is configured to measure the flow rate of the fuel 12 that passed through the first valve V1.

Furthermore, a first fuel remaining quantity sensor S21 detecting the remaining quantity of the fuel 12 stored in the first fuel container 100A is provided between the first fuel pump P31 and the first fuel container 100A. The first fuel remaining quantity sensor S21 measures the remaining quantity of the fuel 12 stored in the fuel storage unit 1A, and outputs an electric signal of the measurement result to the control unit 230.

Similarly, a second fuel remaining quantity sensor S32 detecting the remaining quantity of the fuel 12 stored in the second fuel container 100B is provided between the second fuel pump P32 and the second fuel container 100B. The second fuel remaining quantity sensor S32 measures the remaining quantity of the fuel 12 stored in the fuel storage unit 1B to output an electric signal of the measurement result to the control unit 230.

A second valve V2 is connected to the first water pump P1, and a second flow meter F2 is connected to the second valve V2. The second valve V2 is provided between the first water pump P1 and the vaporizer 211, and is configured to intercept or allow the flow of water from the first water pump P1 to the vaporizer 211 by a switching action thereof. The second flow meter F2 is provided between the second valve V2 and the vaporizer 211, and is configured to measure the flow rate of the water that passed through the second valve V2. The fuel 12 discharged from the first valve V1 and the water discharged from the second valve V2 are mixed with each other before they arrive at the reaction apparatus 210.

The first humidifier 221 and the second humidifier 222 are connected to the second water pump P2, and water is supplied to the first humidifier 221 and the second humidifier 222.

A third valve V3 is provided at a location that is between the water recovery unit 202 and the recovery unit 3A of the first fuel container 100A, and is between the water recovery unit 202 and the recovery unit 3B of the second fuel container 100B. The third valve V3 is configured to intercept or allow the flow of discharges (such as water, gas containing vapor, offgas and the like) from the water recovery unit 202 to the recovery unit (3A or 3B) of the fuel container (100A or 100B) that is supplying the fuel 12, and the flow of discharges from the catalyst combustor 213 to the recovery unit (3A or 3B) of the fuel container (100A or 100B) that is supplying the fuel 12, by a switching action thereof.

Furthermore, a fourth valve V4 is provided at a location that is between the water tank 201 and the cathode of the fuel cell 220, and is between the water tank 201 and the third valve V3. The fourth valve V4 is configured to intercept or allow the flow of the unnecessary water, which is discharged from the cathode of the fuel cell 220, from the second humidifier 222 to the water tank 201, by switching the fourth valve V4 to the water tank 201 side. To put it concretely, in a case where the water in the water tank 201 is a specified quantity or more (full), the fourth valve V4 is controlled to be switched so as to intercept the supply of water to the water tank 201 side and to allow the supply of the water to the third valve V3 side, thus allowing the flow of the water through the third valve V3, the water being discharged from the second humidifier 222, from the second humidifier 222 to the recovery unit (3A or 3B) of the fuel container (100A or 100B) that is supplying the fuel 12. On the other hand, in a case where the water in the water tank 201 is less than the specified quantity, the fourth valve V4 is controlled so as to intercept supply of the water to the third valve V3 side and to perform the supply of the water to the water tank 201 side.

A fifth valve V5, a sixth valve V6 and the second humidifier 222 are connected to the air pump P4. The fifth valve V5 is provided between the air pump P4 and the CO remover 214, and is configured to intercept the flow of air from the air pump P4 to the CO remover 214 or to adjust the flow rate of the air by a switching action thereof.

The sixth valve V6 is provided between the air pump P4 and the catalyst combustor 213, and is configured to intercept the flow of air from the air pump P4 to the catalyst combustor 213 or to adjust the flow rate of the air by a switching action thereof.

The first water pump P1, the second water pump P2, the first fuel pump P31, the second fuel pump P32 and the air pump P4 are electrically connected to the control unit 230 through drivers D1, D2, D31, D32 and D4, respectively. The control unit 230 is composed of, for example, a general purpose central processing unit (CPU), a random access memory (RAM), a read only memory (ROM) and the like. The control unit 230 sends a control signal to each of the first water pump P1, the second water pump P2, the first fuel pump P31, the second fuel pump P32 and the air pump P4, and controls the pumping operation (including adjustment of pump out rate) of each of the first water pump P1, the second water pump P2, the first fuel pump P31, the second fuel pump P32 and the air pump P4.

Further, the first to the sixth valves V1-V6 are electrically connected to the control unit 230 through drivers D11 to D16 respectively, and the first flow meter F1 and the second flow meter F2 are also electrically connected to the control unit 230. By receiving the measurement results of the first flow meter F1 and the second flow meter F2, the control unit 230 can recognize the flow rates of the fuel 12 and water. The control unit 230 is configured so as to be able to control the switching action (including the adjustment of opening quantity) of each of the first to the fourth valves V1-V4, the switching operation of the discharge of the third valve V3 so that the discharges discharged from the power generation module 200 is selectively recovered by the recovery unit which is supplying the fuel 12 to the reaction apparatus 210, the recovery unit being selected between the recovery unit 3A on the side of the first fuel container 100A and the recovery unit 3B on the side of the second fuel container 100B, and the switching operation so that the fourth valve V4 intercepts the supply of water to the water tank 201 side and allows the supply of the water to the third valve V3 side when the quantity of the water in the water tank 201 is the specified quantity or more (full), and the fourth value V4 intercepts the supply of the water to the third valve V3 side and performs the supply of the water to the water tank 201 side when the quantity of the water in the water tank 201 is less than the specified quantity.

Furthermore, the electric heater heating the vaporizer 211, the catalyst combustor 213 and the CO remover 214, is electrically connected to the control unit 230 through a driver D21. The control unit 230 controls amount of heat generated by the electric heater and to stop the operation thereof, and is configured to be able to detect the temperature of the reactor of each of the vaporizer 211, the catalyst combustor 213 and the CO remover 214 by measuring the resistance value of the electric heater, of which the resistance value changes in accordance with temperature. The electric heater may heat the vaporizer 211, the catalyst combustor 213 and the CO remover 214 at the time of startup of the reaction apparatus 210 and may stop or decrease the amount of heat generated when the catalyst combustor 213 becomes able to perform heating stably.

Moreover, the first and the second fuel remaining quantity sensors S21 and S22 and the water remaining quantity sensor S1 are electrically connected to the control unit 230. The control unit 230 determines whether the first and the second fuel containers 100A and 100B are installed or not, and detects the remaining quantity measured by the first fuel remaining quantity sensor S21 and the remaining quantity measured by the second fuel remaining quantity sensor S22. In a case where each of the remaining quantities is less than the specified quantity, the control unit 230 controls the power generation system 300 so as not to start the operation thereof or to stop the operation thereof. In a case where the remaining quantity is the specified quantity or more, the control unit 230 controls the power generation system 300 so as to start the operation thereof or to maintain the operation thereof.

Further, when the power generation system 300 is started, the control unit 230 controls the third valve V3 so as to supply the fuel 12 from the fuel container (100A or 100B) that has the less remaining quantity measured by the first and the second fuel remaining quantity sensors S21 and S22, and to recover the discharges to the recovery unit (3A or 3B) of the same fuel container (100A or 100B) that has the less remaining quantity.

Furthermore, when the remaining quantity measured by the water remaining quantity sensor Si is less than the specified quantity, the control unit 230 controls so as to recover water into the water tank 201; and when the remaining quantity is the specified quantity or more (full), the control unit 230 controls so as to send the water to the recovery unit (3A or 3B) of the fuel container (100A or 100B) that is supplying the fuel 12.

A DC/DC converter 240 is connected to the fuel cell 220, and external equipment (load) capable of operating by being supplied with electric power from an external power source, i.e. the power generation system 300, is connected to the DC/DC converter 240. The DC/DC converter 240 is a device that changes an output voltage of the fuel cell 220 to a predetermined voltage in accordance with the standard of the external electronic equipment, and outputs the changed voltage to the external electronic equipment. The DC/DC converter 240 is connected to the control unit 230, and the control unit 230 is configured to be able to detect the input electric power which is input from the fuel cell 220 to the DC/DC converter 240.

Furthermore, a secondary battery 241 is connected to the DC/DC converter 240. Thus, for example, the connection of the secondary battery 241 enables to store surplus electric energy obtained by the fuel cell 220, and to supply electric power to the external electronic equipment as a substitute of the fuel cell 220 when the generation of electric energy in the fuel cell 220 stops. The control unit 230, each of the drivers, each of the sensors, and the electric heater of the reaction apparatus 210 are electrically driven by a part of the output from the secondary battery 241 through the DC/DC converter 240 at the time of startup, and are then electrically driven by a part of the output from the fuel cell 220 through the DC/DC converter 240 when the output of the fuel cell 220 becomes steady.

The power generation system 300 having the configuration mentioned above is provided in electronic equipment (external electronic equipment) such as a desk top type personal computer, a laptop personal computer, a portable telephone, a personal digital assistant (PDA), an electronic personal organizer, a wrist watch, a digital still camera, a digital video camera, game equipment, an amusement machine, home electronic equipment and the like. The power generation system 300 is used as the power source for operating the external electronic equipment.

Next, the operation of the power generation system 300 is described.

The power generation system 300 operates when an operation signal is input from the external electronic equipment to the control unit 230 through a communication terminal and a communication electrode. The control unit 230 operates the first water pump P1, the second water pump P2 and the air pump P4, and makes the electric heater generate heat through the driver D21. Then, during the operation of the power generation system 300, the control unit 230 controls the temperature so that each electric heater has a predetermined temperature, based on data of the temperature supplied back from each electric heater.

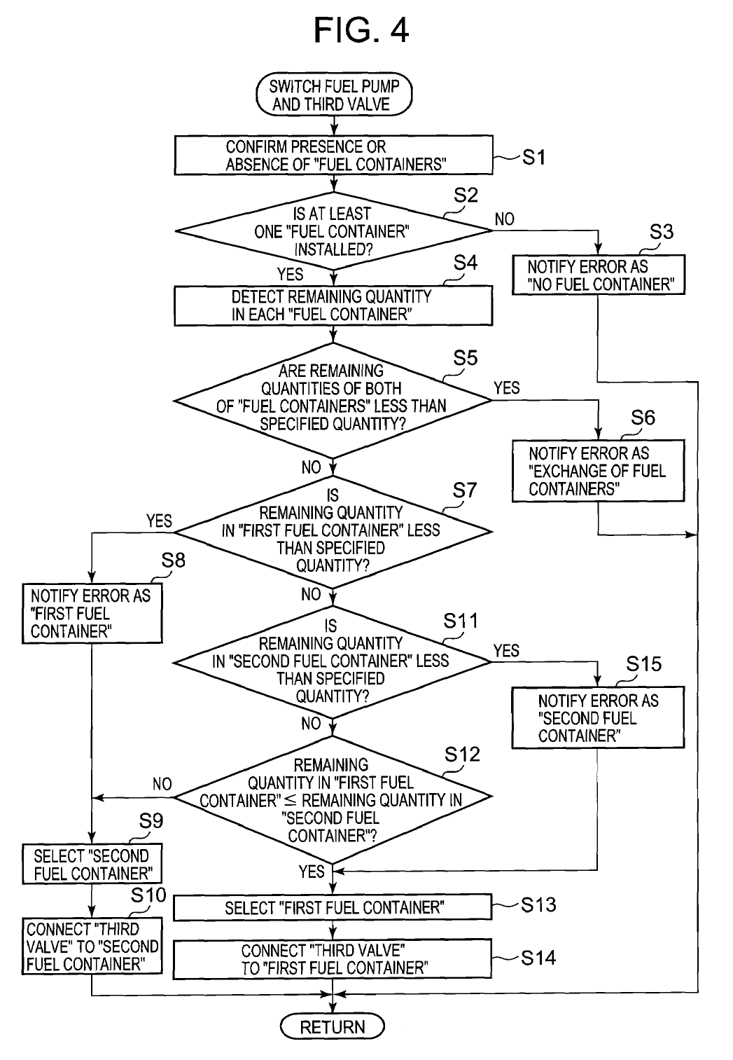

The control unit 230 operates the first or the second fuel pump P31 or P32 and conducts the switching operation of the third valve V3 as follows. FIG. 4 is a flow chart showing the operation of the first or the second fuel pump P31 or P32 and the switching operation processing of the third valve V3.

First of all, the control unit 230 confirms the presence or absence of the installation of the first fuel container 100A and the second fuel container 100B (Step S1). The control unit 230 judges whether at least one fuel container (100A or 100B) is installed or not (Step S2). In a case where both of the fuel containers (100A and 100B) are not installed, the control unit 230 notifies error as “no fuel container” (Step S3). In a case where at least one fuel container (100A or 100B) is installed, the control unit 230 detects the remaining quantity of the fuel 12 with the first and the second fuel remaining quantity sensors S21 and S22 (Step S4). Here, the fuel container (100A or 100B) that is not installed is regarded to have the remaining quantity less than a quantity (specified quantity) which is sufficient for the fuel cell 220 to generate electricity.

Then, the control unit 230 determines whether the remaining quantities of both of the first and the second fuel containers 100A and 100B are less than the specified quantity or not (Step S5). In a case where the remaining quantities of both of the first and the second fuel containers 100A and 100B are less than the specified quantity, the control unit 230 notifies error as “exchange fuel containers” (Step S6). In a case where the remaining quantity of at least one fuel container (100A or 100B) is not less than the specified quantity, the control unit 230 determines whether the remaining quantity of the first fuel container 100A is less than the specified quantity or not (Step S7). In a case where the remaining quantity of the first fuel container 100A is less than the specified quantity (including a case where the first fuel container 100A is not installed), the control unit 230 notifies error as “first fuel container” (Step S8), and selects the second fuel container 100B and the second fuel pump P31 (Step S9) to connect the third valve V3 to the second fuel container 100B (Step S10).

In Step S7, in a case where the remaining quantity of the first fuel container 100A is not less than the specified quantity, the control unit 230 determines whether the remaining quantity of the second fuel container 100B is less than the specified quantity or not (Step S11). In a case where the remaining quantity of the second fuel container 100B is not less than the specified quantity, the control unit 230 determines whether the remaining quantity of the first fuel container 100A is equal to the remaining quantity of the second fuel container 100B or less (Step S12). In Step S12, in a case where the remaining quantity of the first fuel container 100A is more than the remaining quantity of the second fuel container 100B, the control unit 230 selects the second fuel container 100B and the second fuel pump P32 (Step S9), and then connects the third valve V3 to the second fuel container 100B (Step S10).

In Step S12, in a case where the remaining quantity of the first fuel container 100A is equal to the remaining quantity of the second fuel container 100B or less, the control unit 230 selects the first fuel container 100A and the first fuel pump P31 (Step S13), and connects the third valve V3 to the first fuel container 100A (Step S14).

In Step S11, in a case where the remaining quantity of the second fuel container 100B is less than the specified quantity, the control unit 230 notifies error as “second fuel container” (Step S15), and then selects the first fuel container 100A and the first fuel pump P31 (Step S13) to connect the third valve V3 to the first fuel container 100A (Step S14).

The control unit 230 periodically executes the flow of FIG. 4 in the above manner. The control unit 230 monitors the presence or absence of the installation of the first and the second fuel containers 100A and 100B, and operates the first fuel pump P31 or the second fuel pump P32 based on the remaining quantity of each of the fuel containers 100A and 100B, and switch the third valve V3 to the fuel container (for example, the first fuel container 100A) which is to be used. Then, when the control unit 230 repeats the above flow until the fuel 12 of one of the fuel containers (for example, the first fuel container 100A) is used up, the control unit 230 uses the other one of the fuel containers (for example, the second fuel container 100B), and similarly repeats the above flow until the fuel 12 of the other one of the fuel containers (for example, the second fuel container 100B) is used up. When the fuel 12 of both of the fuel containers 100A and 100B are used up, the control unit 230 notifies error so as to exchange the fuel containers, and stops the operation of the power generation system 300. When the fuel containers are exchanged to new fuel containers, the power generation system 300 operates, and the above flow is executed. Thus, continuous operations can be performed.

Next, operation after the switching operation of the fuel container (100A or 100B) by the third valve V3 is described.

Here, for convenience of description, the following description is given to an exemplified case where both of the first fuel containers 100A and the second fuel container 100B are installed in the power generation system 300, the remaining quantity of the first fuel container 100A is equal to or less than the remaining quantity of the second fuel container 100B and is also sufficient for the fuel cell 220 to generate electricity, and the first fuel pump P31 operates.

When the first fuel pump P31 which has been selected by the above flow operates, the fuel 12 in the fuel storage unit 1A of the first fuel container 100A is sent from the fuel discharge unit 11 to the vaporizer 211 of the reaction apparatus 210 through the first valve V1 and the first flow meter F1. Furthermore, when the second water pump P2 operates, the water in the water tank 201 is sent to the first and the second humidifiers 221 and 222 provided on the cathode side of the fuel cell 220. When the air pump P4 operates, the air in the open air is sent to the catalyst combustor 213 through the sixth valve V6, and is sent to the carbon monoxide remover 214 through the fifth valve V5. By the operation of the air pump P4, the air in the open air is sent to the second humidifier 222. Here, the control unit 230 controls each of the valves V1-V4 based on the data of the flow rates supplied back from each of the flow meters F1 and F2, so that the flow rates are predetermined flow rates.

In the vaporizer 211, the supplied fuel 12 and water are heated to vaporize (evaporate), to generate gaseous mixture of the methanol and water (vapor), and the gaseous mixture is supplied to the reformer 212.

In the reformer 212, the methanol and the vapor in the gaseous mixture supplied from the vaporizer 211 undergo reaction by the catalyst, and carbon dioxide and hydrogen are generated (see the above chemical reaction equation (1)). In the reformer 212, successive to the chemical reaction expressed by the chemical reaction equation (1), carbon monoxide is generated (see the above chemical reaction equation (2)). Then, the gaseous mixture including the carbon monoxide, the carbon dioxide, the hydrogen and the like generated in the reformer 212 is supplied to the CO remover 214.

In the CO remover 214, carbon dioxide and hydrogen are generated from the carbon monoxide and the vapor in the gaseous mixture supplied from the reformer 212, and carbon dioxide is generated from the carbon monoxide specifically-selected from the gaseous mixture and the oxygen contained in the air supplied from the fifth valve V5 (see the above chemical reaction equation (3)).

As described above, carbon dioxide and hydrogen are generated from the fuel 12 that has passed through the vaporizer 211, the reformer 212 and the CO remover 214 of the reaction apparatus 210. The reformed gas (such as the carbon dioxide and the hydrogen) generated in the reaction apparatus 210 is supplied to the first humidifier 221. The first humidifier 221 receives water supplied through the second water pump P2 and the second humidifier 222 by switching the fourth valve V4 to the water tank 201 side, and humidifies the reformed gas. Then, the humidified reformed gas is supplied to the anode of the fuel cell 220.

The hydrogen in the reformed gas, which is supplied to the anode of the fuel cell 220, is separated to hydrogen ion and electron as expressed by the chemical reaction equation (4).

On the other hand, air is supplied to the second humidifier 222 through the air pump P4. The second humidifier 222 receives the supply of water through the second water pump P2 by switching the fourth valve V4 to the water tank 201 side, and humidifies the air by allowing the air pass through the water. Then, the humidified air is supplied to the cathode of the fuel cell 220.

The oxygen in the air, which is supplied to the cathode of the fuel cell 220, reacts with the hydrogen ion and the electron as expressed by the chemical reaction equation (5), and water is generated as a by-product.

Here, at the anode side, the unreacted hydrogen is sent to the catalyst combustor 213 as an offgas to be combusted therein, and is used as the energy suitably heating the reaction apparatus 210 as needed. The exhausted gas obtained by the combustion in the catalyst combustor 213 is sent to the third valve V3 and is selectively sent to the recovery unit 3A of the first fuel container 100A, which is supplying the fuel 12. After that the exhausted gas is cooled, the water 13 is recovered in the recovery unit 3A, and gas is discharged through the gas-liquid separation membrane 2A containing the hydrophobic membrane.

At the cathode side, the supplied air is discharged together with the water, which is a by-product, and is sent to the water recovery unit 202. The sent air and the water are subjected to vapor-liquid separation by the gas-liquid separation membrane 203, and the water is stored in the water tank 201 to be reused. The gas containing the vapor is sent to the recovery unit 3A of the first fuel container 100A. Then, the gas is cooled, to liquefy a part of the gas. Subsequently, the liquefied water 13 is recovered by the recovery unit 3A, and the remaining gas that has not been liquefied and contains carbon dioxide is discharged through the gas-liquid separation membrane 2. The water 13 recovered in the recovery unit 3A pushes the fuel storage unit 1A from behind, and thus it becomes easy to discharge the fuel 12 from the fuel discharge unit 11.

Moreover, in a case where the water remaining quantity sensor S1 detects that the quantity of the water in the water tank 201 has become equal to the specified quantity or more (full), the fourth valve V4 switches the supply of water from the water tank 201 side to the third valve V3 side, and the excessive water 13 is sent to the recovery unit 3A of the first fuel container 100A. Consequently, the excessive water 13 is not recovered by the recovery unit 3B of the second fuel container 100B, which is not supplying the fuel 12. As a result, since the fuel storage unit 1B of the second fuel container 100B has a sufficient capacity, the recovery unit 3B is not damaged or is exploded even though the capacity of the recovery unit 3B is not sufficient to recover the water 13.

The electric energy generated by the fuel cell 220 is charged to the secondary battery 241. Furthermore, the generated electric energy is supplied to the DC/DC converter 240, and is converted to a predetermined voltage of a direct current by the DC/DC converter 240 to be supplied to the external electronic equipment. The external electronic equipment operates by the supplied electric energy.

Here, in a case where the remaining quantity of the first fuel container 100A is larger than the remaining quantity of the second fuel container 100B and the second fuel pump P32 operates, the overall operation is the same as mentioned above except that the fuel 12 is supplied from the second fuel container 100B and the discharges are selectively discharged to the second fuel container 100B. Accordingly, the description of this case is omitted.

As described above, according to the power generation system 300, since the discharge route of the discharges is switched by the third valve V3 so that the discharges are recovered by the recovery unit (3A or 3B) of the fuel container (100A or 100B) that is supplying the fuel 12, no pressure is applied to the fuel container (100A or 100B) that is not supplying the fuel 12. Consequently, there are no chances of the leakage of fuel 12 from the fuel container (100A or 100B) that is not used.

Moreover, since no discharge is sent to the fuel container (100A or 100B) that is not supplying the fuel 12, there is no chance of spreading and leaking of the water 13 from the gas-liquid separation membrane (2A or 2B) including the hydrophobic porous membrane, the spreading and the leaking caused by the pressure applied to the recovered water 13.

In particular, fuel supply is performed from the fuel container (100A or 100B) having less remaining quantity detected by the first fuel remaining quantity sensor S21 and the second fuel remaining quantity sensor S22 and the discharges are recovered to the recovery unit (3A or 3B) of the fuel container (100A or 100B) having less remaining quantity. Therefore, the fuel 12 in the fuel container (100A or 100B) having the less remaining quantity is preferentially used. As a result, the water 13 can be recovered to the recovery unit (3A or 3B) having the increased capacity, which is due to the decrease of the fuel 12, and excellent recovery efficiency of the power generation system 300 is achieved.

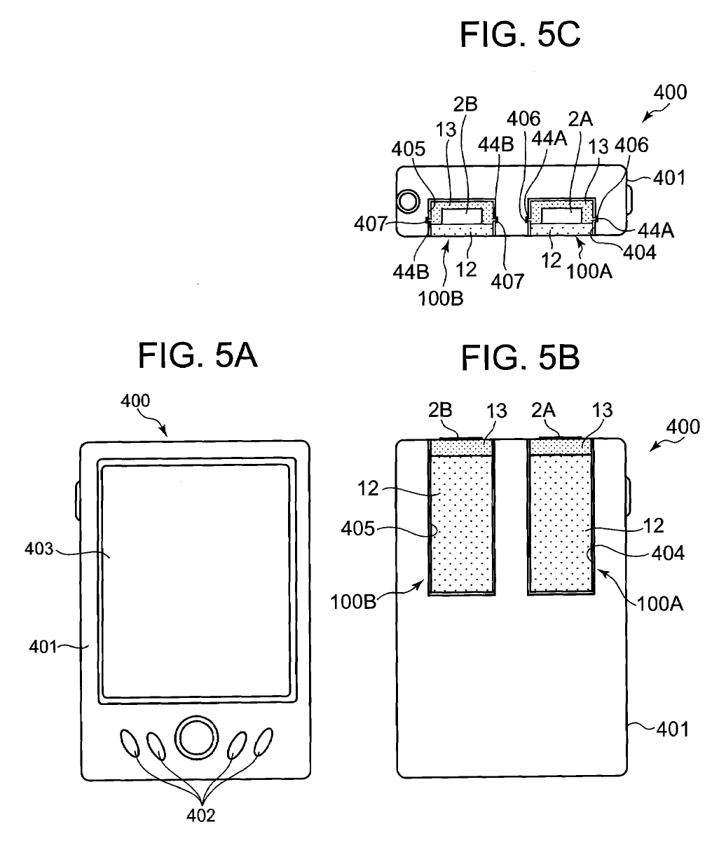

Next, a case where the power generation system 300 is applied to the electronic equipment 400 is described. In particular, this is the case where the power generation system 300 is applied to a PDA, which is a portable electronic equipment. FIG. 5A is a top view of the electronic equipment 400, FIG. 5B is a bottom view of the electronic equipment 400 of FIG. 5A when seen from the bottom side thereof, and FIG. 5C is a rear view of the electronic equipment 400 of FIG. 5B when seen from the rear face side thereof.

The electronic equipment 400 is provided with the main body 401 which is installed with an arithmetic processing circuit composed of electronic parts such as a CPU, a RAM, a ROM and the like, the first fuel container 100A and the second fuel container 100B that are freely attachable and detachable to the main body 401 and reserves the fuel 12, and a power generation module (not shown). The power generation module is provided in the main body 401 to generate electricity by using the fuel 12 in the first and the second fuel containers 100A and 100B and supplies the generated electric energy to the main body 401 so as to drive the main body 401. Here, since the configurations and the operations of the first and the second fuel containers 100A and 100B, and the power generation module (not shown) are similar to the ones described above, their descriptions are omitted.

The main body 401 is provided with operation keys 402 and a liquid crystal display 403. A rectangular first housing space 404 and a rectangular second housing space 405, each of them opened at the bottom surface thereof and at the rear surface thereof and extending in the front and rear direction thereof so as to be bilaterally symmetrical with respect to the center line in the longitudinal direction of the main body 401, are formed on the bottom surface of the main body 401. The main body 401 is configured so that the first fuel container 100A and the second fuel container 100B can be housed in these first and second housing spaces 404 and 405 respectively, by inserting the fuel containers from the openings on the rear surface of the main body 401. Moreover, rail units 406, 406 and 407, 407 are formed on the wall surfaces of the first and the second housing spaces 404 and 405 in the lengthwise directions. The rail units 406, 406 and 407, 407 engage with guide units 44A, 44A and 44B, 44B respectively, the guide units 44A, 44A and 44B, 44B being formed on the fuel containers 100A and 100B, respectively. Accordingly, the first fuel container 100A and the second fuel container 100B are installed in the housing spaces 404 and 405 respectively, by sliding each of the fuel containers 100A and 100B from the end side of the discharge and supply openings, with the end side of the gas-liquid separation membranes 2A and 2B facing the outside, and by the engagement of the guide units 44A, 44A and 44B, 44B with the rail units 406, 406 and 407, 407.

As described above, since the fuel containers 100A and 100B are housed in the housing spaces 404 and 405 respectively, with their bottom surfaces exposed to the outside, the fuel containers 100A and 100B are exposed to the outer atmosphere, and thus good heat radiation performance is obtained, and heat is not maintained in the power generation system 300, resulting in high water recovery rate.

### Second Embodiment

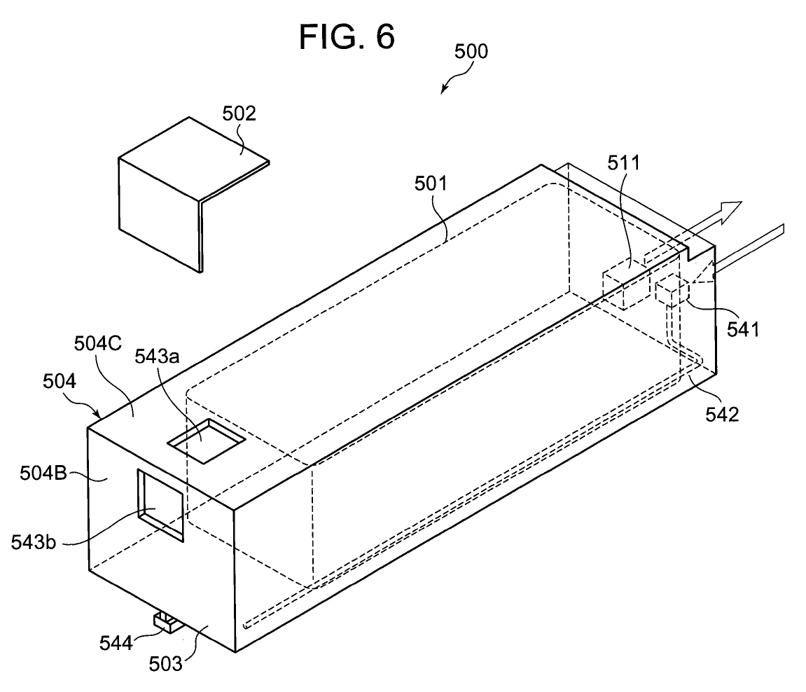

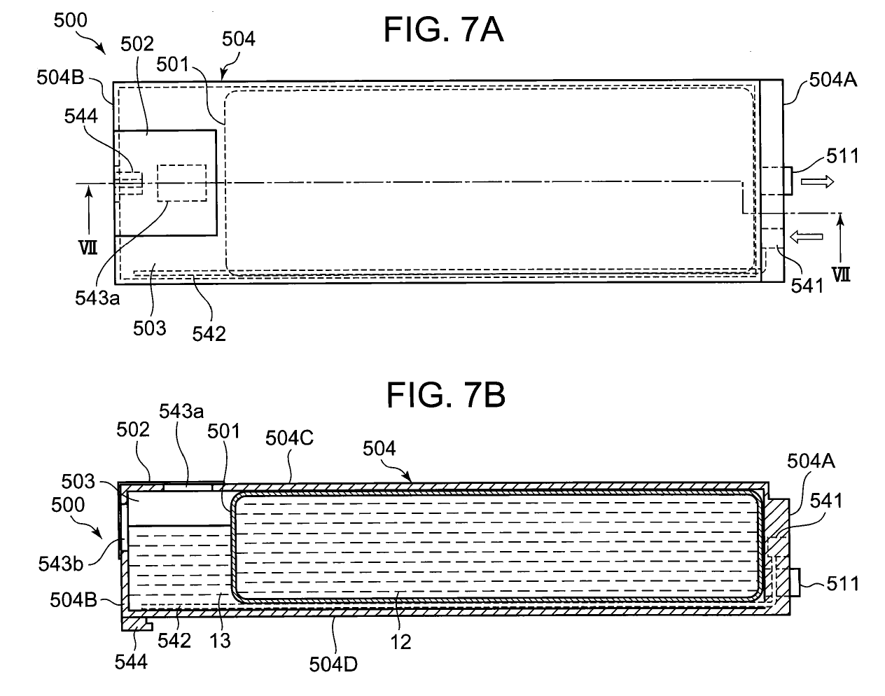

FIG. 6 is an exploded perspective view of a fuel container 500, FIG. 7A is a top view of the fuel container 500, and FIG. 7B is a cross-sectional view when the fuel container 500 is cut along a cutting plane line VII-VII and is viewed from the direction indicated by arrows.

The fuel container 500 is different from the fuel container 100 of the first embodiment with respect to opening portions 543a and 543b that are formed on a housing 504, a gas-liquid separation membrane 502 including a hydrophobic porous membrane that is attached on these opening portions 543a and 543b, and a guide unit 544. Since fuel storage unit 501, recovery unit 503, fuel discharge unit 511, discharge supply unit 541 and discharge supply pipe 542 are the ones similar to the fuel storage unit 1, the recovery unit 3, the fuel discharge unit 11, the discharge supply unit 41 and the discharge supply pipe 42, respectively, their descriptions are omitted.

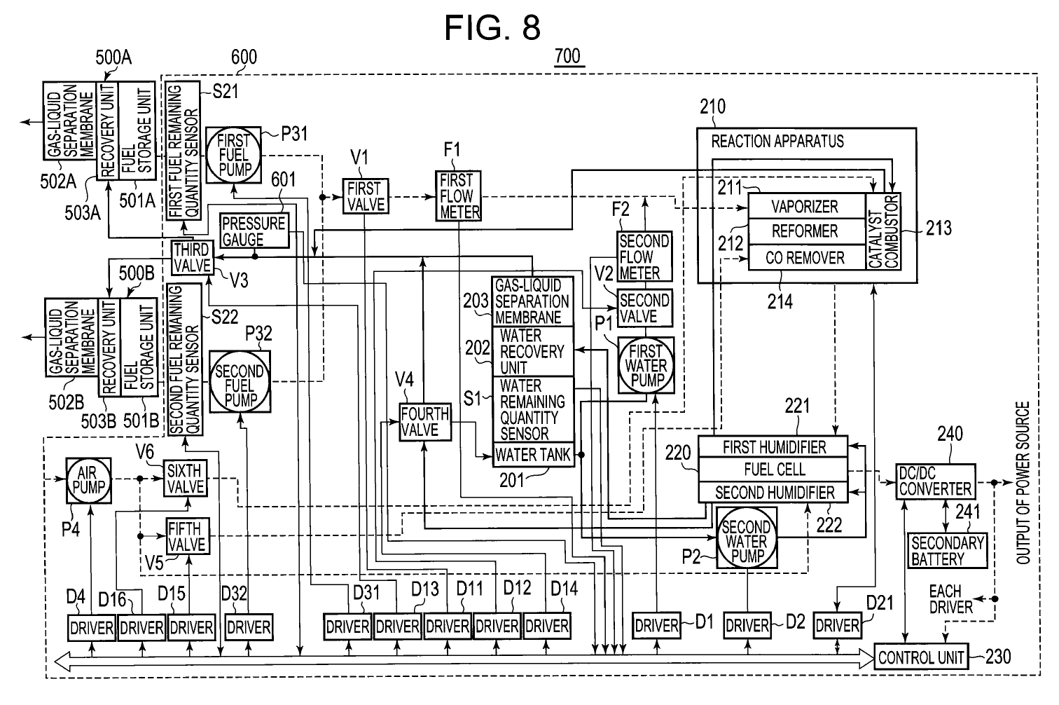

The fuel container 500 is provided with the fuel storage unit 501 storing the fuel 12, and the recovery unit 503 that cools and recovers the discharges containing the gas and the water 13, the gas and the water being discharged from a power generation module 600 (see FIG. 8). The power generation module 600 generates electricity by the supply of the fuel 12 from the fuel storage unit 501.

The fuel discharge unit 511 is formed on the fuel storage unit 501, and the recovery unit 503 is formed as a spacial portion on the outside of the fuel storage unit 501 and is on the left side in the housing 504.

The fuel discharge unit 511 formed on the fuel storage unit 501 penetrates the end face 504A, which is on the right side of the housing 504, and projects to the outside. Moreover, the discharge supply unit 541 is formed at a location that is above the fuel discharge unit 511 and is on the end face 504A of the right side of the housing 504. A fuel discharge opening (not shown) is formed to the fuel discharge unit 511, and a discharge supply opening (not shown) is formed to the discharge supply unit 541. Moreover, as described above, a check valve (not shown) is fitted into the fuel discharge opening and the discharge supply opening. The discharge supply pipe 542 is coupled with the discharge supply unit 541. The discharge supply pipe 542 is provided on the bottom side of the fuel storage unit 501, and extends towards the spacial portion at the left end portion in the housing 504, along the lengthwise direction.

A rectangular opening portion 543a communicating with the inside of the housing 504 is formed on the top surface 504C in the other end face 504B (the end face on the left side in FIG. 6) in the lengthwise direction of the housing 504, and a rectangular opening portion 543b communicating with the inside of the housing 504 is formed in the end face 504B on the left side. Then, the gas-liquid separation membrane 502 is attached to these opening portions 543a and 543b in the state of being bent, thus being laid across the two opening portions 543a and 543b so as to cover the opening portions 543a and 543b. Consequently, gases can pass through the gas-liquid separation membrane 502 from the inside of the housing 504 to the outside thereof and vice versa, and the water 13 cannot pass through the gas-liquid separation membrane 502. Therefore, the water 13 does not leak to the outside. Moreover, since the gas-liquid separation membrane 502 is attached so as to be laid across the two opening portions 543a and 543b, the gases can be discharged from the two portions, the opening portions 543a and 543b.

Furthermore, the guide unit 544 for allowing attachable and detachable installation to electronic equipment 800, which will be described later, is provided to the left end part of the bottom surface 504D of the housing 504. The guide unit 544 is shaped so that the sectional side view thereof is a letter T, the letter T projecting from the bottom surface 504D of the housing 504 to the lower side (see FIG. 6).

In the fuel container 500 mentioned above, the fuel 12 in the fuel storage unit 501 is supplied to the power generation module 600, which will be described later, through the fuel discharge unit 511, and electric energy is extracted by using the fuel 12. Moreover, the discharges generated by the power generation module 600 are supplied to the discharge supply pipe 542 through the discharge supply unit 541, and then the discharges flow through the discharge supply pipe 542 to be sent to the recovery unit 503. The gases in the discharges are cooled while flowing the inside of the discharge supply pipe 542, and a part of the gasses is condensed to generate water 13. Then, the water 13 is recovered by the recovery unit 503. The gases that have not been condensed pass through the gas-liquid separation membrane 502 to be discharged to the outside. Since the water 13 cannot pass through the gas-liquid separation membrane 502, the water 13 is reserved in the recovery unit 503. Moreover, the cooling of the discharges is accelerated also by the water 13 that is charged in the recovery unit 503 in advance, and the discharges are condensed.

FIG. 8 is a block diagram showing the schematic configuration of a power generation system 700 provided with a first fuel container 500A and a second fuel container 500B, each having a configuration similar to that of the fuel container 500 mentioned above, and the power generation module 600.

Here, since each component constituting the first fuel container 500A corresponds to each component of the fuel container 500 mentioned above, each component of the first fuel container 500A is denoted by a reference numeral including the letter A added to the reference numeral of the corresponding component of the fuel container 500 in the following descriptions. In the same manner, each component of the second fuel container 500B is denoted by a reference numeral including the letter B added to the reference numeral of the corresponding component of the fuel container 500. Moreover, since the power generation system 700 in the second embodiment is provided with a pressure gauge 601 between the third valve V3 and the fifth valve V5 and the other configuration of the power generation system 700 is similar to that of the power generation system 300 of the first embodiment, the similar components in each configuration are denoted by the same reference marks, and their descriptions are omitted.

The pressure gauge 601 measures the pressure of the fuel container (500A or 500B), to which the third valve V3 is connected, and outputs an electric signal of the measurement result to the control unit 230.

Then, in a case where the measurement result of the pressure gauge 601 is equal to a predetermined pressure or more, the control unit 230 switches the third valve V3 to connect the third valve V3 to the other fuel container (500A or 500B), and measure the pressure loss of fuel container (500A or 500B). The control unit 230 controls the operation of the first or the second fuel pump P31 or P32 and the switching operation of the third valve V3 so as to supply the fuel 12 from the fuel container (500A or 500B) having the lower pressure loss, and to recover the discharges to the same fuel container (500A or 500B). In a case where both of the measured pressure losses are high in the same degree, the control unit 230 controls the operations of the first and the second fuel pumps P31 and P32 and the switching operation of the third valve V3 so as to supply the fuel 12 from both of the fuel containers 500A and 500B, and recover the discharges to the both fuel containers 500A and 500B.

For example, concerning the case where the third valve V3 is connected to the first fuel container 500A, in a case where the control unit 230 detects abnormal pressure, which is a predetermined pressure or more, from a measurement result of the pressure gauge 601, the control unit 230 switches the third valve V3 to the second fuel container 500B to measure the pressure loss from the measurement result of the pressure gauge 601. Then, in a case where the pressure loss of the second fuel container 500B is lower than that of the first fuel container 500A, the control unit 230 selects the second fuel pump P32, and the third valve V3 cancels the connection with the first fuel container 500A to be connected with the second fuel container 500B.

On the other hand, in a case where the pressure losses of the first fuel containers 500A and the second fuel container 500B are high in the same degree, the control unit 230 selects both of the fuel pumps P31 and P32, and connects the third valve V3 to both of the fuel containers 500A and 500B. Then, the control unit 230 operates the first fuel container 500A and the second fuel container 500B gradually and simultaneously, and sends discharges to both of the fuel containers 500A and 500B. Thereby, the control unit 230 lowers the pressure losses of both of the fuel containers 500A and 500B as much as possible, and discharges the discharges.

Similarly, concerning the case where the third valve V3 is connected to the second fuel container 500B, in a case where the control unit 230 detects abnormal pressure, which is predetermined pressure or more, from a measurement result of the pressure gauge 601, the control unit 230 switches the third valve V3 to the first fuel container 500A to measure the pressure loss from the measurement result of the pressure gauge 601. Then, in a case where the pressure loss of the first fuel container 500A is lower than that of the second fuel container 500B, the control unit 230 selects the first fuel pump P31, and the third valve V3 cancels the connection with the second fuel container 500B to be connected with the first fuel container 500A.

On the other hand, in a case where the pressure losses of the first fuel container 500A and the second fuel container 500B are high in the same degree, the control unit 230 selects both of the fuel pumps P31 and P32, and connects the third valve V3 to both of the fuel containers 500A and 500B. Then, the control unit 230 operates the first fuel container 500A and the second fuel container 500B gradually and simultaneously, and sends discharges to both of the fuel containers 500A and 500B. Thereby, the control unit 230 lowers the pressure losses of both of the fuel containers 500A and 500B as much as possible, and discharges the discharges.

As described above, according to the power generation system 700, in a case where the pressure value by the pressure gauge 601 is equal to the predetermined pressure or more, the fuel is supplied from the fuel container (500A or 500B) having a lower pressure loss, and the discharges are recovered to the recovery unit (503A or 503B) of the same fuel container (500A or 500B). Consequently, even in a case where the gas-liquid separation membrane (502A or 502B) including the hydrophobic porous membrane of one of the fuel containers 500A and 500B is obstructed by the recovered water 13 or is obstructed by a hand or a substance from the outside and thus the pressure loss is high, it is possible to perform exhaustion by selecting the fuel container (500A or 500B) that has a low pressure loss and the gas-liquid separation membrane (502A or 502B) thereof is not obstructed.

Moreover, in a case where both of the pressure losses are high in the same degree, fuel is supplied from both of the fuel containers 500A and 500B simultaneously and both of the recovery units 503A and 503B recover the discharges simultaneously. Consequently, it is possible to perform the exhaustion to both of the fuel containers 500A and 500B with the pressure losses lowered as much as possible. As a result, a back flow can be prevented.

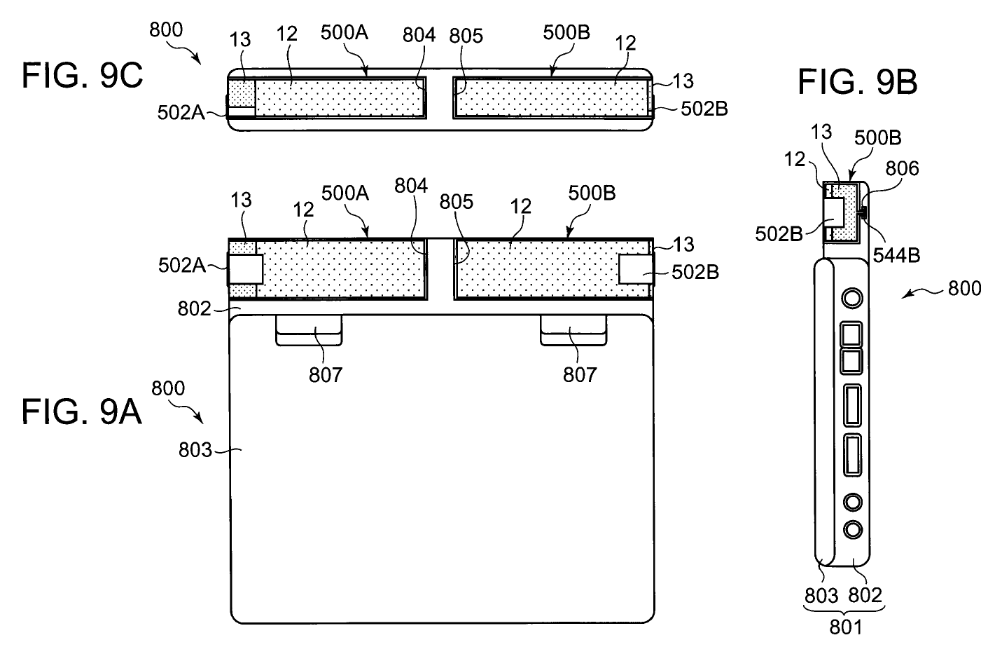

Next, a case where the power generation system 700 is applied to the electronic equipment 800 is described. In particular, a case where the power generation system 700 is applied to a lap top personal computer, which is a portable electronic equipment, is described. FIG. 9A is the top view of the electronic equipment 800, FIG. 9B is the right side view of the electronic equipment 800 of FIG. 9A when seen from the right side, and FIG. 9C is the rear view of the electronic equipment 800 of FIG. 9A when seen from the rear face side.

The electronic equipment 800 is provided with the main body 801 which is installed with an arithmetic processing circuit composed of electronic parts such as a CPU, a RAM, a ROM and the like, the first fuel container 500A and the second fuel container 500B that are freely attachable and detachable to the main body 801 and reserves the fuel 12, and a power generation module (not shown). The power generation module is provided in the main body 801 to generate electricity by using the fuel 12 in the first and the second fuel containers 500A and 500B and supplies the generated electric energy to the main body 801 so as to drive the main body 801. Here, since the configurations and the operations of the first and the second fuel containers 500A and 500B, and the power generation module (not shown) are similar to the ones described above, their descriptions are omitted.

The main body 801 is provided with a lower housing 802 equipped with a keyboard and an upper housing 803 equipped with a liquid crystal display. The upper housing 803 is coupled to the lower housing 802 with a hinge 807. The main body 801 is configured to be able to be folded with the upper housing 803 being superposed on the lower housing 802 to make the keyboard face the liquid display. The upper housing 803 is formed to have shorter length than the lower housing 802, in the front and rear direction, and is configured to be able to be folded on the lower housing 802 with their front ends being arrayed. Consequently, a part of the top surface in the rear side of the lower housing 802 is exposed without being covered by the upper housing 803 when the upper housing 803 is superposed on the lower housing 802.

A rectangular first housing space 804 with openings on the top surface, the left side surface and the rear surface thereof is formed to extend from right to left with respect to the center line in the front to rear direction of the main body 801. A rectangular second housing space 805 with openings on the top surface, the right side surface and the rear surface thereof is formed to extend from right to left with respect to the center line in the front to rear direction of the main body 801. Both of the housing spaces 804 and 805 are formed so as to be bilaterally symmetrical with respect to the center line in the front to rear direction of the main body 801, on the exposed portion of the lower housing 802.

The first housing 804 is configured so that the first fuel container 500A can be inserted from the opening on the left side to be housed therein. Moreover, a rail unit (not shown) engaging with a guide unit (not shown) formed on the bottom surface of the first fuel container 500A is formed on the left end part of the lowermost part constituting the first housing space 804.

The second housing space 805 is configured so that the second fuel container 500B can be inserted from the opening on the right side to be housed therein, and a rail unit 806 engaging with the guide unit 544B of the second fuel container 500B is formed at the right end on the lowermost part constituting the second housing space 805.

Accordingly, the first fuel container 500A and the second fuel container 500B are installed in the housing spaces 804 and 805, respectively, by sliding each of the fuel containers 500A and 500B from the end side of the discharge and supply openings with the ends side of the gas-liquid separation membranes 502A and 502B facing the outside, and by the engagement of the guide unit 544B with the rail unit 806.

As described above, since the fuel containers 500A and 500B are housed in the housing spaces 804 and 805 respectively, with their bottom surfaces exposed to the outside, the fuel containers 500A and 500B are exposed to the outer atmosphere, and thus good heat radiation performance is obtained, and heat is not maintained in the power generation system 700, resulting in high water recovery rate.

Here, the present invention is not limited to the embodiments described above, and the embodiments can be suitably modified so long as it does not deviate from the subject matter of the invention.

For example, although the power generation systems 300 and 700 in the embodiments described above are provided with two fuel containers of the first fuel containers 100A and 500A and the second fuel containers 100B and 500B, the power generation system may be provided with three or more fuel containers.

Moreover, although the first and the second fuel containers 100 and 500 are configured to provide the bag-like shaped fuel storage units 1 and 501 in the housings 4 and 504, the configuration of the fuel container of the invention is not limited to the above configurations. As long as the configuration is capable of separating the fuel 12 and the recovered water 13, such configuration can be adopted. For example, a partition plate (not shown) partitioning the space portion of each of the housings 4 and 504 may be provided in each of the housings 4 and 504, to store the fuel 12 or to recover the water 13 in each space partitioned by the partition plate. Moreover, a separation liquid capable of separating the fuel 12 and the water 13 may be provided in each of the housings 4 and 504.

Although the second embodiment performs the switching of the first fuel container 500A and the second fuel container 500B with the pressure gauge 601 and the third valve V3, a purge valve that opens by a certain pressure or more may be provided in place of the pressure gauge 601 and the third valve V3.

Moreover, the shape of each component of each of the fuel containers 100 and 500 can be suitably modified. For example, although the opening portions 43, 543a and 543b are made to be rectangular, the opening portion may be formed using many holes.

Moreover, although each of the embodiments is provided with the reaction apparatus 210 to supply the fuel to the fuel cell after reforming the fuel, the power generation module with a direct type fuel cell that supplies the fuel directly from the first and the second fuel containers 100 and 500 without providing the reaction apparatus 210 may be adopted.

The entire disclosure of Japanese Patent Application No. 2006-093930 filed on Mar. 30, 2006 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A power generation module comprising:
a fuel take-in unit to take in fuel from at least one of a plurality of fuel containers, the fuel take-in unit being coupled with the plurality of fuel containers;
a power generator to generate electricity by using the fuel supplied from the at least one of the plurality of fuel containers; and
a by-product discharger to discharge a by-product, which is generated during the generation of the electricity by the power generator, selectively to the at least one of the plurality of fuel containers.

2. The power generation module according to claim 1, further comprising a remaining quantity detector to detect a remaining quantity of the fuel in the plurality of fuel containers, wherein
the fuel take-in unit takes in the fuel from a fuel container or fuel containers of the plurality of fuel containers, which has the remaining quantity detected by the remaining quantity detector that is less than that of the other fuel containers of the plurality of fuel containers, and
the by-product discharger discharges the by-product so that the fuel container or the fuel containers recovers the by-product.

3. The power generation module according to claim 1, further comprising a pressure detector to detect a pressure in the plurality of fuel containers, wherein
in a case where a pressure value detected by the pressure detector is equal to a predetermined pressure or more, the fuel take-in unit takes in the fuel from a fuel container or fuel containers of the plurality of fuel containers, which has a pressure loss that is lower than that of the other fuel containers of the plurality of fuel containers, and the by-product discharger discharges the by-product to the fuel container or the fuel containers so as to recover the by-product.

4. The power generation module according to claim 1, further comprising a reaction apparatus to reform the fuel taken into the fuel take-in unit.

5. The power generation module according to claim 1, further comprising a tank to recover a part of the by-product generated by the power generator, wherein
the by-product discharger discharges a remainder of the by-product after the part of the by-product is recovered by the tank, so that the at least one of the plurality of fuel containers recover the remainder of the by-product.

6. The power generation module according to claim 5, wherein the remainder of the by-product is separated from the part of the by-product by a gas-liquid separation membrane.

7. The power generation module according to claim 1, wherein
the fuel take-in unit is coupled with a fuel storage unit of each of the plurality of fuel containers, and
the by-product discharger is coupled with a recovery unit of each of the plurality of fuel containers.

8. The power generation module according to claim 7, wherein
the at least one of the plurality of fuel containers that is coupled to the by-product discharger recovers a part of the by-product taken in by the recovery unit as liquid, and discharge another part of the by-product as a gas to the outside of the at least one of the plurality of fuel containers.

9. The power generation module according to claim 1, wherein each of the at least one of the plurality of fuel containers that are coupled to the by-product discharger is provided with a gas-liquid separation membrane to discharge a part of the by-product as a gas to the outside of the at least one of the plurality of fuel containers.

10. The power generation module according to claim 9, wherein
each of the plurality of fuel containers is installed in the power generation module so that the gas-liquid separation membrane is exposed to the outside of the power generation module.

11. A system comprising:
the power generation module according to claim 1; and
an electronic equipment that operates based on electric energy generated by the power generation module.

12. A power generation module comprising:
a fuel take-in unit to take in fuel from a plurality of fuel containers simultaneously, in a case where a pressure value of each of the plurality of fuel containers is equal to a predetermined pressure or more and a pressure loss in each of the plurality of fuel containers is substantially the same, the fuel take-in unit being coupled with the plurality of fuel containers;
a power generator to generate electricity by using the fuel supplied from the plurality of fuel containers; and
a by-product discharger to discharge a by-product which is generated during the generation of the electricity by the power generator, to the plurality of fuel containers simultaneously.

13. The power generation module according to claim 12, further comprising a reaction apparatus to reform the fuel taken into the fuel take-in unit.

14. The power generation module according to claim 12, further comprising a tank to recover a part of the by-product generated by the power generator, wherein
the by-product discharger discharges a remainder of the by-product after the part of the by-product is recovered by the tank, so that the at least one of the plurality of fuel containers recover the remainder of the by-product.

15. The power generation module according to claim 14, wherein the remainder of the by-product is separated from the part of the by-product by a gas-liquid separation membrane.

16. The power generation module according to claim 12, wherein
the fuel take-in unit is coupled with a fuel storage unit of each of the plurality of fuel containers, and
the by-product discharger is coupled with a recovery unit of each of the plurality of fuel containers.

17. The power generation module according to claim 16, wherein
the at least one of the plurality of fuel containers that is coupled to the by-product discharger recovers a part of the by-product taken in by the recovery unit as liquid, and discharge another part of the by-product as a gas to the outside of the at least one of the plurality of fuel containers.

18. The power generation module according to claim 12, wherein each of the at least one of the plurality of fuel containers that are coupled to the by-product discharger is provided with a gas-liquid separation membrane to discharge a part of the by-product as a gas to the outside of the at least one of the plurality of fuel containers.

19. The power generation module according to claim 18, wherein
each of the plurality of fuel containers is installed in the power generation module so that the gas-liquid separation membrane is exposed to the outside of the power generation module.

20. A system comprising:
the power generation module according to claim 12; and
an electronic equipment that operates based on electric energy generated by the power generation module.

21. A method of driving a power generation module comprising the steps of:
taking in fuel from at least one of a plurality of fuel containers, in a state of being coupled with the plurality of fuel containers;
generating electricity by using the fuel supplied from the at least one of the plurality of fuel containers; and
discharging a by-product which is generated during the generation of the electricity, to the at least one of the plurality of fuel containers selectively.
